(19) United States
(12) Patent Application Publication
(10) Pub. No.: US 2020/0256694 A1
(43) Pub. Date: Aug. 13, 2020

(54) INFORMATION PROCESSING DEVICE, INFORMATION PROCESSING METHOD, AND STORAGE MEDIUM

(71) Applicants: TOYOTA JIDOSHA KABUSHIKI KAISHA, Toyota-shi (JP); Hitachi Solutions, Ltd., Tokyo (JP)

(72) Inventors: Yuichiro UEDA, Chiryu-shi (JP); Atsuko KOBAYASHI, Nagoya-shi (JP); Akira IIJIMA, Nagoya-shi (JP); Daisuke TANABE, Nisshin-shi (JP); Manabu YAMAMOTO, Toyota-shi (JP); Hiroyuki GOTO, Ichinomiya-shi (JP)

(73) Assignees: TOYOTA JIDOSHA KABUSHIKI KAISHA, Toyota-shi (JP); Hitachi Solutions, Ltd., Tokyo (JP)

(21) Appl. No.: 16/782,418

(22) Filed: Feb. 5, 2020

(30) Foreign Application Priority Data
Feb. 12, 2019 (JP) 2019-022740

(51) Int. Cl. G01C 21/36; G08G 1/0968; G01C 21/34

(52) U.S. Cl. CPC G01C 21/3617; G01C 21/343; G01C 21/3484; G08G 1/096888

(57) ABSTRACT

An information processing device that provides information to a user is provided. The information processing device includes a control unit configured to identify facilities corresponding to a user attribute including user needs, preferences, or characteristics, to acquire a travel history that includes visited locations visited during past travels by the user carrying at least one of the information processing device and another device used by the user, and to output information on an unvisited facility to the user. The unvisited facility is included in the facilities corresponding to the user attribute and is located at a location other than the visited locations recorded in the travel history.

### INCORPORATION BY REFERENCE

The disclosure of Japanese Patent Application No. 2019-022740 filed on Feb. 12, 2019 including the specification, drawings and abstract is incorporated herein by reference in its entirety.

### BACKGROUND

### 1. Technical Field

The present disclosure relates to an information processing device, an information processing method, and a storage medium.

### 2. Description of Related Art

Recently, the information communication technique for use in a mobile object, such as a vehicle, has become more sophisticated. For example, the navigation device disclosed in Japanese Patent Application Publication No. 2007-263920 (JP 2007-263920 A) allows the user to easily listen to a large amount of music via simple operations. At the same time, this navigation device allows the user to reliably select desired music and to receive the information about a route to a store where the desired music can be purchased.

### SUMMARY

It is desired to appropriately provide the information on various facilities, such as facilities not only for providing music as described above but also for providing products or services that meet the user needs, preferences, or characteristics, in response to a user request. The present disclosure increases the opportunities for users to select appropriate facilities in various situations.

A first aspect of the present disclosure relates to an information processing device that provides information to a user. The information processing device includes a control unit configured to identify facilities corresponding to a user attribute including user needs, preferences, or characteristics, acquire a travel history that includes visited locations visited during past travels by the user carrying at least one of the information processing device and another device used by the user, and output information on an unvisited facility to the user, wherein the unvisited facility is included in the facilities corresponding to the user attribute and is located at a location other than the visited locations recorded in the travel history.

In the first aspect described above, the control unit may be further configured to output, to the user, information on the unvisited facility as well as information on a region that includes a location where the unvisited facility is located.

In the aspect described above, the information on the region that includes the location may include sightseeing information on sightseeing spots in the region that includes the location or information on a production area of special products in the region that includes the location.

In the aspect described above, the control unit may be further configured to acquire information on the user attribute. The control unit may be further configured to identify the facilities corresponding to the user attribute based on the information on the user attribute.

In the aspect described above, the control unit may be further configured to acquire information on facilities related to a behavior pattern of the user. The control unit may be further configured to select an unvisited facility from facilities that are included in the facilities corresponding to the user attribute and that are facilities other than the facilities related to the behavior pattern.

In the aspect described above, the control unit may be further configured to identify a region where the number of visits during the past travels is equal to or greater than a predetermined number based on the travel history. The control unit may be further configured to identify facilities corresponding to the user attribute from facilities located in the region where the number of visits is equal to or greater than the predetermined number.

In the first aspect described above, the control unit may be further configured to determine whether there is the unvisited facility in the facilities corresponding to the user attribute based on the travel history.

In the first aspect described above, the control unit may be further configured to give priority to the unvisited facility or limit the facilities to the unvisited facility from among the facilities corresponding to the user attribute, and output the information on the unvisited facility to the user.

A second aspect of the present disclosure relates to an information processing method that provides information to a user. The information processing method includes identifying facilities corresponding to a user attribute including user needs, preferences, or characteristics, acquiring a travel history that includes visited locations visited during past travels by the user carrying at least one of an information processing device and another device used by the user, and outputting information on an unvisited facility to the user wherein the unvisited facility is included in the facilities corresponding to the user attribute and is located at a location other than the visited locations recorded in the travel history.

In the second aspect described above, the information processing method may further include outputting, to the user, information on the unvisited facility as well as information on a region that includes a location where the unvisited facility is located.

In the aspect described above, the information on the region that includes the location may include sightseeing information on sightseeing spots in the region that includes the location or information on a production area of special products in the region that includes the location.

In the aspect described above, the information processing method may further include acquiring information on the user attribute. The information processing method may further include identifying the facilities corresponding to the user attribute based on the information on the user attribute.

In the aspect described above, the information processing method may further include acquiring information on facilities related to a behavior pattern of the user. The information processing method may further include selecting an unvisited facility from facilities that are included in the facilities corresponding to the user attribute and that are facilities other than the facilities related to the behavior pattern.

In the aspect described above, the information processing method may further include identifying a region where the number of visits during the past travels is equal to or greater than a predetermined number based on the travel history. The information processing method may further include identifying facilities corresponding to the user attribute from facilities located in the region where the number of visits is equal to or greater than the predetermined number.

In the second aspect described above, the information processing method may further include determining whether there is the unvisited facility in the facilities corresponding to the user attribute based on the travel history.

In the second aspect described above, the information processing method may further include giving priority to the unvisited facility or limiting the facilities to the unvisited facility from among the facilities corresponding to the user attribute. The information processing method may further include outputting the information on the unvisited facility to the user.

A third aspect of the present disclosure relates to a non-transitory storage medium storing instructions that are executable by one or more processors and that cause the one or more processors to perform functions. The functions includes identifying facilities corresponding to a user attribute including user needs, preferences, or characteristics, acquiring a travel history that includes visited locations visited during past travels by the user carrying at least one of an information processing device and another device used by the user, and outputting information on an unvisited facility to the user wherein the unvisited facility is included in the facilities corresponding to the user attribute and is located at a location other than the visited locations recorded in the travel history.

According to the aspects of the present disclosure, it is possible to increase the opportunities for the user to select an appropriate facility.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing an example of a configuration of an information system in an embodiment;

FIG. 2 is a diagram showing an example of a configuration of a user attribute DB;

FIG. 3 is a diagram showing an example of a configuration of a facility DB;

FIG. 4 is a diagram showing an example of a configuration of a travel history DB;

FIG. 5 is a diagram showing an example of a configuration of a travel history aggregation DB;

FIG. 6 is a diagram showing an example of a configuration of a related information DB; and

FIG. 7 is a diagram showing an example of the processing of an information processing device.

### DETAILED DESCRIPTION OF EMBODIMENTS

An information processing device in one embodiment will be described below with reference to the drawings. In this embodiment, the information processing device prompts the user to make a decision for selecting an appropriate facility from the facilities located in the regions related to the user. For example, the information processing device assumes a case in which the user is provided with a desired product or service in the region where the user resides or in the region near to the user's workplace. Even in such a region related to the user, there may be a facility that the user has not yet visited. This information processing device assists the user to visit a facility that is located in the regions related to the user and matches the user's attribute but has never been visited by the user.

In one aspect, the information processing device identifies facilities corresponding to the user attribute including user needs, preferences, or characteristics. After that, the information processing device acquires a travel history that includes visited locations visited during past travels by the user carrying at least one of the information processing device itself and another device used by the user. After that, the information processing device outputs the information on an unvisited facility to the user, wherein the unvisited facility is included in the facilities corresponding to the user attribute and is located at a location other than the visited locations recorded in the travel history.

The facilities described above include a store that provides products, an organization that provides services, or a building where services are provided. An example of a facility corresponding to the user attribute is an extracted facility that matches the user based on the user attribute such as the needs, preferences, or characteristics of the user.

The travel history of the information processing device, such as an in-vehicle device, a mobile phone, or a smartphone, refers to the travel history of the information processing device itself acquired by the global positioning system (GPS) function installed in the information processing device. An example of another device used by the user is a device that travels with the user (such as in-vehicle device, mobile phone, or smartphone) and that works with the information processing device via the network when the information processing device is, for example, a server not equipped with the GPS function. The information processing device includes a control unit, in which computer programs are loaded, to perform the processing and the method described above. The information processing device may output, to the user, the information on a facility at an unvisited location as well as the information on the region including the location where the unvisited facility is located.

The information on the region including the location includes the community-specific information provided by the local government of the region, the sightseeing information on the sightseeing spots in the region, or the information for introducing the production locations of the special products in the region. The information processing device outputs the such information on a region as well as the information on an unvisited facility to the user so that the user can easily visit the unvisited facility. In this way, the information processing device allows the user to become familiar with a facility in the region or to find an opportunity to visit the facility.

The information processing device identifies regions where the number of visits during the past travels is equal to or greater than a predetermined number based on the travel history described above. After that, from the facilities located in the regions identified by the information processing device, the information processing device identifies the facilities that match the user attribute. That is, the information processing device identifies the facilities in the regions related to the user, making it possible to set an environment in which the user can find it easier to visit an unvisited facility that is easily accessible but has not yet been visited.

In addition, the information processing device may acquire facilities related to a user's behavior pattern and may select a facility, located at an unvisited location, from the facilities that are included in the facilities corresponding to the user attribute and that are facilities other than the facilities related to the user's behavior pattern. The behavior pattern, also called a routine, can be identified from the user's schedule information or the travel history. The behavior patterns include going to a pool every Wednesday after work, going to a restaurant on Friday at the end of every month, or going to a certain shrine or temple at the beginning of every new year.

### EMBODIMENT

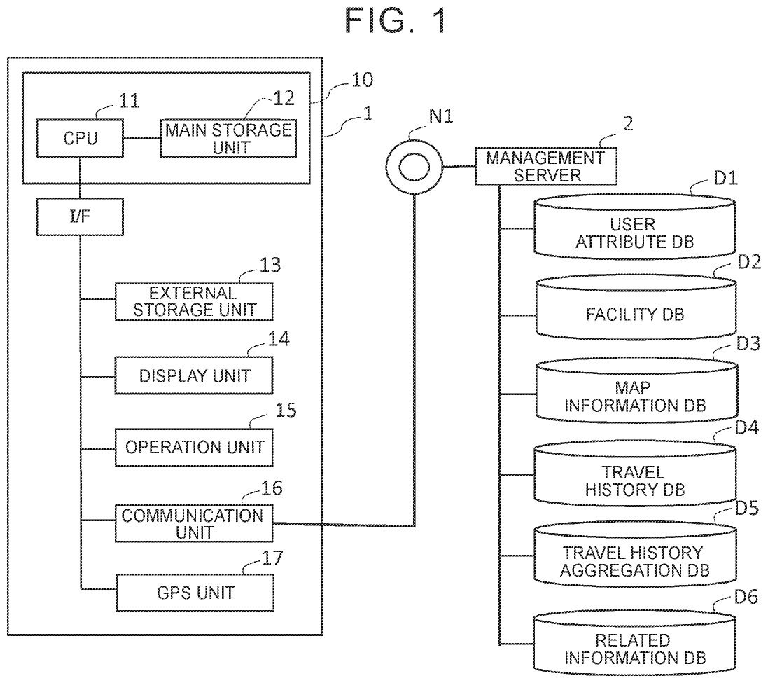

FIG. 1 shows an example of a configuration of an information system in this embodiment. As shown in FIG. 1, this information system includes an information processing device 1 and a management server 2. The information processing device 1, such as an in-vehicle device mounted on a vehicle, is a device that travels with a mobile object such as a vehicle. Note that the information processing device 1 may also be a device called a smartphone, a mobile phone, or a personal digital terminal or may be a laptop-type portable personal computer.

The information processing device 1 includes a CPU 11, a main storage unit 12, and external units that are connected through and an interface (I/F). The information processing device 1 executes programs to perform information processing. The CPU 11 is also called a processor. The CPU 11 is not limited to a single processor but may be a multiprocessor in which a plurality of processors cooperates to perform processing or a multi core processor that has a plurality of arithmetic processing devices. The CPU 11 may include not only a general-purpose processor but also a dedicated processor, which performs image processing, signal processing, machine learning processing, product-sum operation processing, or vector operation processing at high speed or in parallel, and a dedicated digital circuit. The main storage unit 12 is an example of a main storage device. Examples of external devices include an external storage unit 13, a display unit 14, an operation unit 15, a communication unit 16, and a GPS unit 17.

The CPU 11, which executes computer programs that are read into in the main storage unit 12 in an executable form, provides the function of the information processing device 1. The main storage unit 12 stores computer programs to be executed by the CPU 11 and data to be processed by the CPU 11. The main storage unit 12 is a dynamic random access memory (DRAM), a static random access memory (SRAM), a read only memory (ROM), or the like. The CPU 11 and the main storage unit 12 may be called a control unit 10. The control unit 10, which executes computer programs to control the information processing device 1, performs the information processing method in this embodiment.

The external storage unit 13, used for example as a storage area for assisting the main storage unit 12, stores computer programs to be executed by the CPU 11 and data to be processed by the CPU 11. The external storage unit 13 is a hard disk drive, a solid state drive (SSD), or the like. Furthermore, the information processing device 1 may be provided with a drive device for a removable storage medium. Examples of a removable storage medium include a Blu-ray disc, a digital versatile disc (DVD), a compact disc (CD), and a flash memory card.

The display unit 14 is, for example, a liquid crystal display or an electroluminescence panel. The operation unit 15 is, for example, a keyboard or a pointing device. In this embodiment, a touch panel is used as an example of the pointing device. The communication unit 16 sends or receives data to or from other devices on the network such as a server that provides services to mobile objects or users. The communication unit 16 is, for example, a wireless communication device that accesses a mobile phone network, a wireless communication device that accesses a wireless local area network (wireless LAN), or a communication device that accesses a LAN. The GPS unit 17 has the function of a global positioning system (GPS) receiver. The GPS unit 17 receives radio waves from satellites and acquires its own current position (latitude, longitude) and the current time.

The management server 2, connected to the information processing device 1 via a network N1, provides various services to the information processing device 1. The management server 2 is similar to the information processing device 1 except that the management server 2 is not limited to a portable device, with the configuration similar to that of the information processing device 1. That is, the management server 2 includes the CPU 11, the main storage unit 12, the external storage unit 13, and so on.

An example of the network N1 is a public communication network such as the Internet. Note that a part of the network N1 may be a wireless communication network such as a mobile phone network or a wireless LAN.

The management server 2 has a user attribute DB D1 (hereinafter a database is referred to simply as a DB), a facility DB D2, a map information DB D3, a travel history DB D4, a travel history aggregation DB D5, and a related information DB D6. In response to a request from the information processing device 1, the management server 2 provides various types of information, stored in the user attribute DB D1, the facility DB D2, the map information DB D3, the travel history DB D4, the travel history aggregation DB D5, and the related information DB D6, to the information processing device 1. Although details are omitted in the description below, the map information DB D3, which is a part of what is also referred to as geographic information system (GIS), includes the information on lands, facilities, and roads in the form of raster data and vector data.

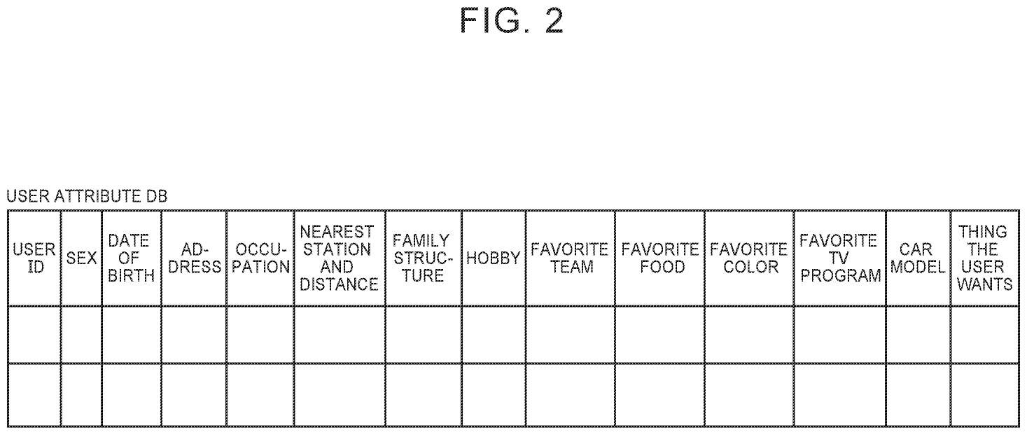

FIG. 2 shows an example of the configuration of the user attribute DB D1. The user attribute DB D1 stores user attribute including user needs, preferences, or characteristics. As shown in FIG. 2, a record of the user attribute DB D1 includes the following elements: user ID, sex, date of birth, address, occupation, nearest station and distance, family structure, hobby, favorite team, favorite food, favorite color, favorite TV program, car model, and thing the user wants. In response to an input from the user via the information processing device 1, the management server 2 update, as necessary, the record stored in the user attribute DB D1 and corresponding to the user. When the user registers himself/herself as a user of the management server 2 to receive its service, the management server 2 may prompt the user to enter the values that are stored in the user attribute DB D1. The values entered at this time are used as the initial values.

The user ID is the information that uniquely identifies the user in the user attribute DB D1. The management server 2 may assign a user ID to each user. Instead of assigning a user ID, the management server 2 may use, as the user ID, the identification information on the information processing device 1 carried by the user, the address of the information processing device 1 on the network N1, or the user's mail address.

The sex, date of birth, address, occupation, nearest station and distance, and family structure are examples of the user characteristics. The user characteristics are described in a predetermined format defined by the management server 2. For example, “sex=1” means a man and “sex=2” means a woman. The hobby, favorite team, favorite food, favorite color, favorite TV program, and car model are examples of the user preferences or user needs. The thing the user wants, which is a thing or a service the user wants to get, is another example of user needs. The user preferences and needs may be described in character strings, or any of the numbers corresponding a group of corresponding terms may be assigned. For example, “favorite color=1” means {red, RED}.

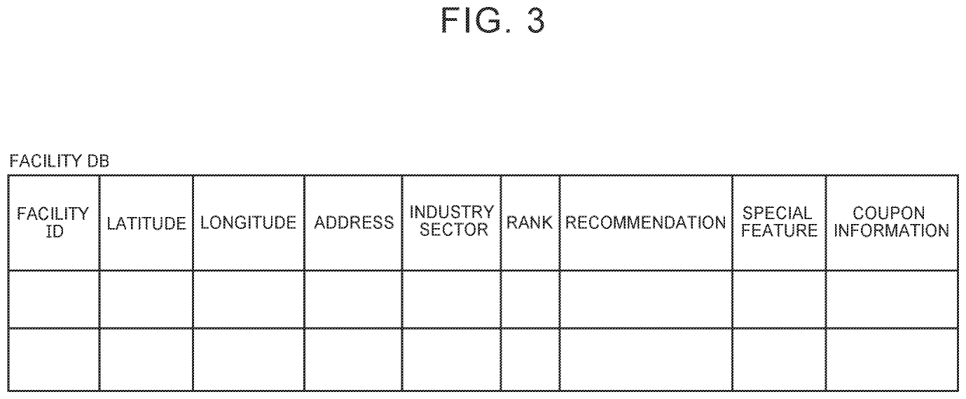

FIG. 3 shows an example of the configuration of the facility DB D2. The facility DB D2 stores the information on the facilities each of which can be a candidate for use by the user. Each record of the facility DB D2 includes the following elements: facility ID, latitude, longitude, address, industry sector, rank, recommendation, special feature, and coupon information. The facility ID is the information that uniquely identifies a facility in the facility DB D2. The management server 2 may assign a facility ID to each facility or, when the manager of the management server 2 enters the facility ID of a facility, may give the entered facility ID to that facility. The latitude and the longitude is the information that indicates the location of the facility identified by the facility ID. The address is a character string that indicates the address of the facility.

The industry sector is a generic term for a business operated by the facility, for a product or a group of products sold by the facility, or for a service provided by the facility. The industry sector may be specified by a number indicating an industry sector. For example, the industry sector is specified as “1=restaurant”, “2=one-day hot spring”, and “3=convenience store”. The industry sector may also be specified by a character string.

The rank is the information that indicates the price level or the service level of the facility determined by the average customer spend at the facility and the questionnaire survey collected from the visitors. The rank is set using, for example, alphabets (A to F, etc.) or numbers 1 to 10. The recommendation is the information that identifies the goods or services that the facility currently recommends to customers. For example, the recommendation is represented by a character string or a keyword that indicates the information on the menu items of a restaurant or the accommodation plans of an accommodation facility. The special feature is the information that identifies the quality or characteristics of a product or a service that the facility wants to appeal to its customers. For example, the special feature is represented by a character string or a keyword that indicates the information on the production area and the grade of materials used in a restaurant, the information on the award history of a service provider, the information that indicates the facilities, the information that indicates the environment, facilities, or service quality of an accommodation facility, and the information that indicates the manufacturer or the material of the products provided by the store.

The coupon information is the information that indicates the conditions for granting a coupon and the points given under those conditions. An example of such coupon information is that “100 yen worth of points is granted to each visitor from 2:00 pm to 5:00 pm”. The coupon information may simply indicate a point for the purchase amount. An example of such coupon information is that “10 points are given for each 1000 yen as a common point when the purchase amount is 1000 yen or more”.

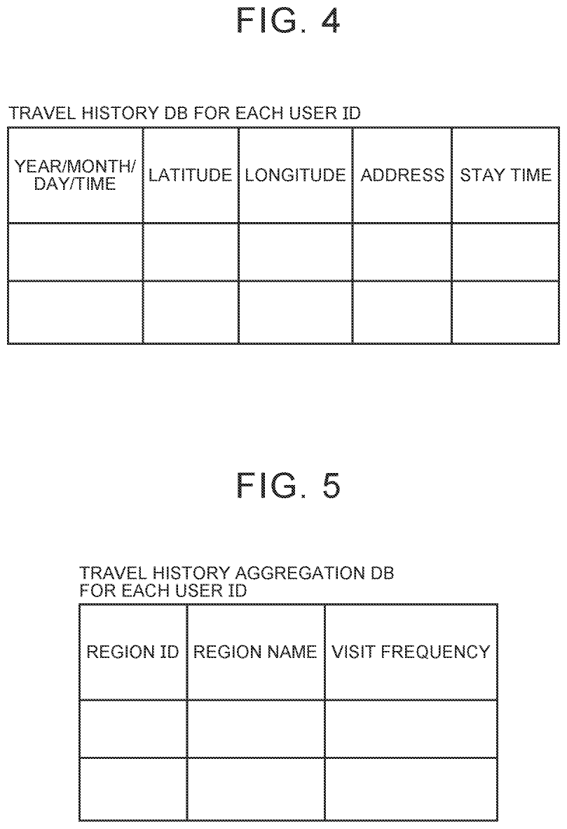

FIG. 4 shows an example of the configuration of the travel history DB D4. The travel history DB D4 is a database for collecting the travel history of each user (for each user ID). A record of the travel history DB D4 has the following elements: year/month/day/time, latitude, longitude, address, and stay time. The user ID related to one travel history DB D4 is the same user ID used in the user attribute DB D1 shown in FIG. 2. The year/month/day/time is the year, month, day, and time at which the record was recorded. The year/month/day/time may be the time at which the information processing device 1 arrived at the location indicated by the latitude and the longitude.

The latitude, the longitude, and the address are the latitude, the longitude, and the address of the location where the information processing device 1 was located when the record was recorded. The stay time is the time for which the information processing device 1 stayed at the location. The stay time may have the arrival time at the location and the elapsed time at the location. The stay time may also have the arrival time at the location and the leaving time from the location.

The stay time may be calculated by either the information processing device 1 or the management server 2. The information processing device 1 may determine whether the information processing device 1 has left the location by determining whether the information processing device 1 has left a predetermined geographical range that includes the location specified by the latitude and longitude. The predetermined geographical range is a range specified, for example, as a range of 1 km, 100 m, 10 mm, 1/120 degree, or 1/1000 degree from the location, specified by the latitude and longitude, to the north, south, east, and west. When a location indicated by the latitude and longitude is represented by its addresses, the predetermined geographical range is, for example, a range within a city, a district, or a town or a range in the same street (chome) and the same number.

FIG. 5 is a diagram showing an example of the configuration of the travel history aggregation DB D5. The travel history aggregation DB D5 includes the information generated by aggregating, for each region, the results stored in the travel history DB D4. A record of the travel history aggregation DB D5 includes the following elements: region ID, region name, and visit frequency. The region ID is the identification information that identifies a region. The region may be a predetermined geographical range described in FIG. 4. For example, when a location indicated by the latitude and longitude is represented by its addresses, the region may be specified as a range within a city, a district, or a town or a range in the same street (chome) and same number. The region name may be the name of a region identified by the address. Note that the region name includes the street (chome) and the number. The region name may include the building name or the apartment name. The visit frequency is the number of visits to the region per given period (year, month, etc.), that is, the actual number of visits recorded in the travel history. In FIG. 5, the region corresponding to a record that contains the visit frequency value equal to or greater than a predetermined value is an example of a region where the number of visits during the past travels is equal to or greater than a predetermined value.

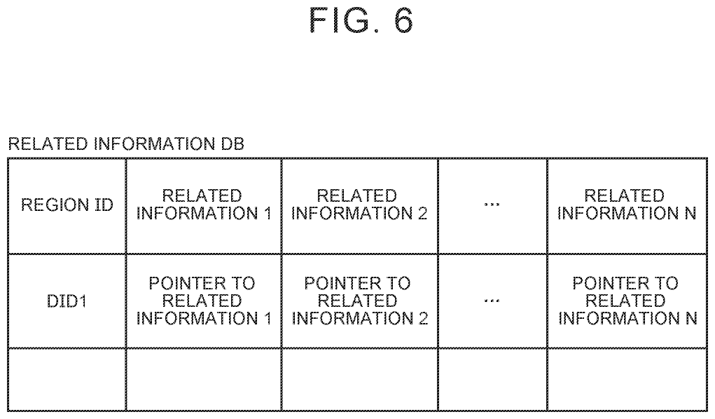

FIG. 6 is a diagram showing an example of the configuration of the related information DB D6. A record of the related information DB D6 includes the following elements: region ID, related information 1, related information 2, . . . , related information N. The region ID is the identification information that identifies a region, as described in FIG. 5. Each of the related information 1 to the related information N contains a pointer to the storage area where the corresponding related information is stored. The number of elements of the related information (value of N in FIG. 6) may be fixed or variable. When one or more pieces of the related information 1, related information 2, . . . , related information N contain an empty pointer, those pieces of related information containing the empty pointer are arranged at the end (on the related information N side). The management server 2 searches related information 1, related information 2, . . . , related information N from the beginning until an element containing an empty pointer (NULL value) is found and, when such an element is found, the management server 2 can get the pointers to all valid related information.

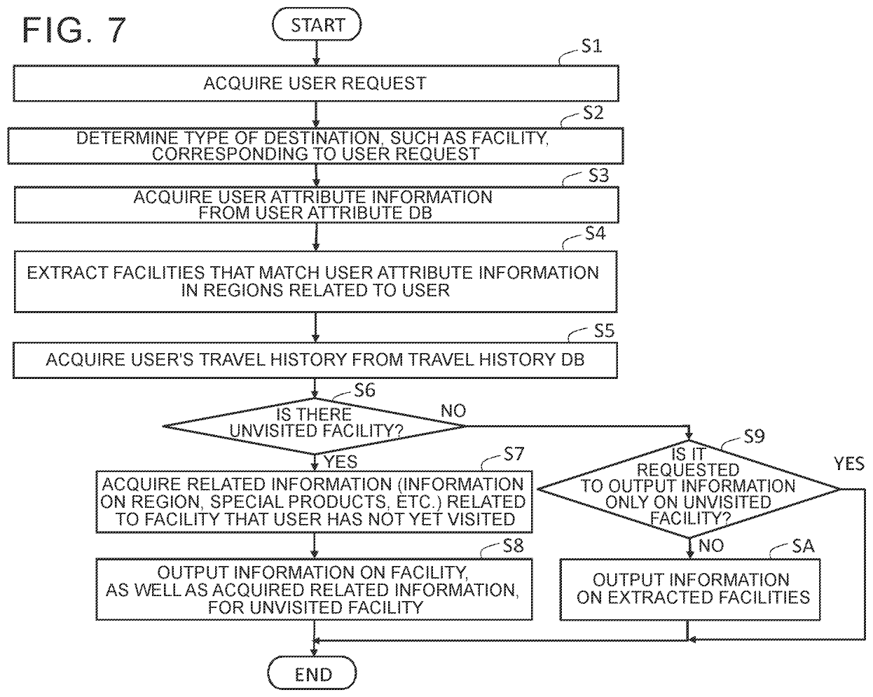

FIG. 7 shows an example of the processing performed by the information processing device 1 in this embodiment. When this processing is started, firstly, the information processing device 1 acquires a user request (S1). The user request is a request of search, issued to the information processing device 1, for a desired product or a desired service. The search request specifies a product name or a service name. The product name is, for example, food, furniture, electrical appliances, sport equipment, clothes, bicycles, and automobiles. The service name is, for example, a meal, accommodation, travel, theatergoing, or sports watching.

In the processing in S1, the information processing device 1 may accept, from the user, a specification giving priority to an unvisited facility or a specification limiting facilities to an unvisited facility. When a specification giving priority to an unvisited facility or a specification limiting facilities to an unvisited facility is accepted, the information processing device 1 follows this specification. That is, the information processing device 1 performs the subsequent processing with priority given to an unvisited facility or with facilities limiting to an unvisited facility.

Next, the information processing device 1 determines the type of destination corresponding to the user request (S2). For example, when a request for food is received, the type of destination is a store such as a supermarket, a convenience store, a department store, or the like. When a request for accommodation is received, the type of destination is an accommodation facility such as a hotel. The relationship between user requests and destination types may be stored in the external storage unit 13 as a table-format dictionary. Note that, when an input of the destination type itself is received from the user in the processing in S1 (for example, when an input of a French restaurant or a sushi restaurant is received), the information processing device 1 may directly use the received type of destination in S2.

Next, the information processing device 1 acquires the user attribute information from the user attribute DB (S3). The user attribute information has the configuration exemplified by the user attribute DB D1 shown in FIG. 2. After acquiring the user attribute, the information processing device 1 identifies the facilities that match the user attribute information in the regions related to the user (S4). The regions related to the user are regions where the user has visited the number of times equal to or greater than a predetermined number. Such regions include the region where the user resides, the region where the user's workplace is located, or other frequently visited regions. The information processing device 1 may acquire the regions, where the user has visited the number of times equal to or greater than a predetermined number, from the travel history DB D4 shown in FIG. 4 or from the travel history aggregation DB D5 shown in FIG. 5 through the management server 2. The processing in S4 is an example in which the facilities corresponding to the user attribute are identified from the facilities located in the regions where the number of visits is equal to or greater than the predetermined number.

The information processing device 1 may classify the users into clusters based on the user attribute information and then extract the facilities that match each cluster. The facilities that match the user attribute information may be, for example, extracted facilities that match each cluster. The facilities that match each cluster may be determined by the feedback based on the questionnaire results obtained when the information was output to the users in the past. That is, for each user group classified by sex, date of birth (age), occupation, hobby, etc., the matching facilities are selected based on the past questionnaire results. The questionnaire results may be acquired by accumulating reactions, such as satisfaction and dissatisfaction, obtained from the users when the information was output in the past.

The information processing device 1 may determine the correlation among the past questionnaire results, the accumulated reaction results (satisfaction, dissatisfaction), and the information on the rank, recommendation, or special feature of the facilities that match the user attribute information. Then, based on the correlation determined in this way, the information processing device 1 may extract the matching facilities from the facility DB D2. The processing in S4 is an example in which the facilities corresponding to the user attribute, which includes the user needs, preferences, or characteristics, are identified.

Next, the information processing device 1 acquires user's travel history from the travel history DB D4 (S5). The processing in S5 is as an example in which the travel history is acquired that includes the locations visited during the past travels by the user carrying the information processing device. Then, the information processing device 1 checks the facilities identified in S4 to determine whether there is a facility that the user has not yet visited (S6). For example, when the information processing device 1 is an in-vehicle device or a smartphone and has no travel history of visiting the location of the facility, the information processing device 1 may determine that the user has not yet visited the facility. Furthermore, the information processing device 1 may request the management server 2 to search the travel history DB D4 using a user ID that is uniquely identified from an in-vehicle device or a smartphone. When the information processing device 1 is an in-vehicle device, the user may be identified by a camera or a biometric authentication sensor, such as a fingerprint sensor, mounted on the in-vehicle device. In this case, the information processing device 1 may determine the user ID by the user's image or by the biometric authentication information and then request the management server 2 to search the travel history DB D4.

When the facilities extracted in S4 includes a facility that the user has not yet visited, the information processing device 1 acquires, from the related information DB D6, the related information on the facility that the user has not yet visited (S7). The related information on an unvisited facility is as follows: the information on the location at which an unvisited facility is located or on the region including that location, the information on sightseeing spots at the location and on the region including that location, and the information on special products produced at the location or in the region including that location. The information on a location or the region including that location is, for example, the information on the activity of the local government, and the activity of the neighborhood association, at the location or in the region including the location. The information on special products may be the information on seasonal products.

Next, for the unvisited facility, the information processing device 1 outputs the information on the facility as well as the acquired related information (S8). In this case, the information on the facility is, for example, the advertisement information on the facility. When it is requested to output the information only on an unvisited facility, the information processing device 1 may exclude the visited facilities and output the information only on the unvisited facility in the processing in S8. When it is not requested to output the information only on an unvisited facility, the information processing device 1 output, for the visited facilities, only the information on the extracted facilities without including the related information in the processing in S8. The processing in S8 is an example in which the information on the visited facilities at visited locations stored in the travel history is output to the user. The processing in S8 is also an example in which the information on an unvisited facility, as well as the information on the region including the location at which the unvisited facility is located, is output to the user.

When the facilities extracted in S4 does not include a facility that the user has not yet visited, the information processing device 1 determines whether it is requested to output the information only on an unvisited facility (S9). When it is requested to output the information only on an unvisited facility, the information processing device 1 terminates the processing. When it is determined in S9 that it is not requested to output the information only on an unvisited facility, the information processing device 1 may directly output the information on the extracted facilities (SA).

### <Effects of Embodiment>

As described above, the information processing device 1 in this embodiment can extract an unvisited facility from the facilities that match the user attribute including the user need, preferences, or characteristics. As a result, the user can acquire the information on the facilities, including an unvisited facility, that are located in the regions relevant to the user and that are likely to meet the user requirements. In this way, the information processing device 1 allows the user to visit a facility that is likely to meet the requirements in the regions relevant to the user, with a refreshing feeling. In addition, the user can increase the chance of visiting a facility that matches his or her attribute information.

For an unvisited facility, the information processing device 1 outputs the information on the unvisited facility as well as the information related to the unvisited facility. The information related to the facility is, for example, the information on the location at which the facility is located or on the region including that location, the information on special products produced at the location or in the region including that location, and the information on the sightseeing spots in the region. Outputting the facility-related information in this way allows the user to increase the chance of becoming familiar with an unvisited facility that is located in the regions related to the user and is likely to meet the user requirements but is not yet visited. In addition, outputting the information on the special products produced at the location or in the region including that location and the information on the sightseeing spots in the region allows the user to feel familiar with the unvisited facility as well as with the location and the region including that location and to have an interest in an unvisited facility at the location or in the region. As a result, the user can increase the chance of visiting a facility that matches his or her attribute information.

The information processing device 1 identifies, in the processing in S4, the facilities that match the user attribute information in the regions related to the user. The regions related to the user include, for example, the region where the user resides, the region where the user's workplace is located, or the regions where the user has visited the number of times equal to or greater than a predetermined frequency. Therefore, the information processing device 1 can provide the user with the information on an unvisited facility included in the regions that are identified by the user's travel history as frequently visited regions.

### OTHER EMBODIMENTS

The above embodiment is merely an example, and the present disclosure may be implemented by adding modifications within a range not departing from the spirit thereof. For example, in FIG. 1 to FIG. 7, the information processing device 1 performs the processing in FIG. 7 in cooperation with the management server 2. However, instead of this configuration, the information processing device 1 may perform all the processing of the management server 2. That is, the information processing device 1 may have the user attribute DB D1, facility DB D2, map information DB D3, travel history DB D4, travel history aggregation DB D5, and related information DB D6, may manage the information stored in those databases, and may search and utilize the information stored in those databases.

The management server 2 may perform the processing in FIG. 7. In this case, the information processing device 1, such as an in-vehicle device, a mobile phone, or a smartphone, function as an input/output interface with the user and as a position information detector. In addition, the information processing device 1 send a user request and the user position information to the management server 2 via the network N1. Furthermore, the information processing device 1 receive the information about an unvisited facility and the related information about the facility from the management server 2 via the network N1 and to output the received information from the display unit 14. In this case, the information processing device 1 is considered as an example of another device used by the user. In this case, the processing in S5 is an example in which the travel history is acquired that includes the visited locations visited during the past travels of at least one of the other devices used by the user.

In addition, the information processing device 1 receive the information of the facilities corresponding to the user attribute information, from the management server 2 via the network N1. In this case, receiving the information of the facilities is an example of identifying the facilities that match the user attribute information.

In the processing in S6 in FIG. 7 described above, the information processing device 1 references the travel history DB D4 to determine whether the facilities that match the user attribute information include a facility that the user has not yet visited. Instead of this processing, the information processing device 1 or the management server 2 may acquire a user's behavior pattern for selecting a facility not included in the visited facilities included in the behavior pattern. Then, the information processing device 1 or the management server 2 may provide the user with the information on a facility that matches the user attribute information and is not included in the visited facilities indicated by the behavior pattern. The information processing device 1 may acquire a user's behavior pattern from the user's behaviors that occur in correlation with the travels that take place a predetermined number of times or more based on the travel history DB D4. The information processing device 1 may also acquire a user's behavior pattern from the user's schedule information. In this case, it is assumed that the user's schedule information is stored in the information processing device 1 or in the management server 2.

By performing this processing, the information processing device 1 or the management server 2 can provide the information on an unvisited facility so that the user can visit, with a refreshed feeling, an unvisited facility that is located in the regions related to the user and that is likely to meet the user's requirements.

The processing and the units described in this disclosure can be implemented in any combination as long as no technical contradiction occurs.

The processing described as being performed by one device may be performed by two or more devices in a shared manner. Conversely, the processing described as being performed by different devices may be performed by one device. In the computer system, the hardware configuration (server configuration) for implementing each function can be flexibly changed.

The functions described in the above embodiment can also be implemented by loading a computer program into a computer so that one or more processors of the computer can read and execute the program. Such a computer program may be provided to the computer by a non-transitory computer-readable storage medium that can be connected to the computer system bus or may be provided to the computer via a network. The non-transitory computer-readable storage medium includes any type of disk such as a magnetic disk (floppy (registered trademark) disk, hard disk drive (HDD), etc.) and an optical disc (CD-ROM, DVD disc, Blu-ray disc, etc.). The non-transitory computer-readable storage medium also includes any type of medium suitable for storing electronic instructions such as a read-only memory (ROM), a random access memory (RAM), an EPROM, an EEPROM, a magnetic card, a flash memory, and an optical card.

What is claimed is:

1. An information processing device that provides information to a user, comprising:
a control unit configured to
identify facilities corresponding to a user attribute including user needs, preferences, or characteristics;
acquire a travel history that includes visited locations visited during past travels by the user carrying at least one of the information processing device and another device used by the user; and
output information on an unvisited facility to the user, the unvisited facility being included in the facilities corresponding to the user attribute, the unvisited facility being located at a location other than the visited locations recorded in the travel history.

2. The information processing device according to claim 1, wherein
the control unit is further configured to output, to the user, information on the unvisited facility as well as information on a region that includes a location where the unvisited facility is located.

3. The information processing device according to claim 2, wherein
the information on the region that includes the location includes sightseeing information on sightseeing spots in the region that includes the location or information on a production area of special products in the region that includes the location.

4. The information processing device according to claim 1, wherein:
the control unit is further configured to
acquire information on the user attribute; and
identify the facilities corresponding to the user attribute based on the information on the user attribute.

5. The information processing device according to claim 4, wherein:
the control unit is further configured to
acquire information on facilities related to a behavior pattern of the user; and
select an unvisited facility from facilities that are included in the facilities corresponding to the user attribute and that are facilities other than the facilities related to the behavior pattern.

6. The information processing device according to claim 1, wherein:
the control unit is further configured to
identify a region where the number of visits during the past travels is equal to or greater than a predetermined number based on the travel history; and
identify facilities corresponding to the user attribute from facilities located in the region where the number of visits is equal to or greater than the predetermined number.

7. The information processing device according to claim 1, wherein
the control unit is further configured to determine whether there is the unvisited facility in the facilities corresponding to the user attribute based on the travel history.

8. The information processing device according to claim 1, wherein
the control unit is further configured to give priority to the unvisited facility or limit the facilities to the unvisited facility from among the facilities corresponding to the user attribute, and output the information on the unvisited facility to the user.

9. An information processing method that provides information to a user, comprising:
identifying facilities corresponding to a user attribute including user needs, preferences, or characteristics;
acquiring a travel history that includes visited locations visited during past travels by the user carrying at least one of an information processing device and another device used by the user; and
outputting information on an unvisited facility to the user, the unvisited facility being included in the facilities corresponding to the user attribute, the unvisited facility being located at a location other than the visited locations recorded in the travel history.

10. The information processing method according to claim 9, further comprising
outputting, to the user, information on the unvisited facility as well as information on a region that includes a location where the unvisited facility is located.

11. The information processing method according to claim 10, wherein
the information on the region that includes the location includes sightseeing information on sightseeing spots in the region that includes the location or information on a production area of special products in the region that includes the location.

12. The information processing method according to claim 9, further comprising:
acquiring information on the user attribute; and
identifying the facilities corresponding to the user attribute based on the information on the user attribute.

13. The information processing method according to claim 12, further comprising:
acquiring information on facilities related to a behavior pattern of the user; and
selecting an unvisited facility from facilities that are included in the facilities corresponding to the user attribute and that are facilities other than the facilities related to the behavior pattern.

14. The information processing method according to claim 9, further comprising:
identifying a region where the number of visits during the past travels is equal to or greater than a predetermined number based on the travel history; and
identifying facilities corresponding to the user attribute from facilities located in the region where the number of visits is equal to or greater than the predetermined number.

15. The information processing method according to claim 9, further comprising
determining whether there is the unvisited facility in the facilities corresponding to the user attribute based on the travel history.

16. The information processing method according to claim 9, further comprising:
giving priority to the unvisited facility or limiting the facilities to the unvisited facility from among the facilities corresponding to the user attribute; and
outputting the information on the unvisited facility to the user.

17. A non-transitory storage medium storing instructions that are executable by one or more processors and that cause the one or more processors to perform functions comprising:
identifying facilities corresponding to a user attribute including user needs, preferences, or characteristics;
acquiring a travel history that includes visited locations visited during past travels by the user carrying at least one of an information processing device and another device used by the user; and
outputting information on an unvisited facility to the user, the unvisited facility being included in the facilities corresponding to the user attribute, the unvisited facility being located at a location other than the visited locations recorded in the travel history.
